(19) United States
(12) Patent Application Publication
(10) Pub. No.: US 2006/0273178 A1
(43) Pub. Date: Dec. 7, 2006

(54) Portable reference tool of drink mixing cards

(76) Inventor: Michael Tsang, New York, NY (US)

Correspondence Address: MILDE & HOFFBERG, LLP, 10 BANK STREET, SUITE 460, WHITE PLAINS, NY, 10606, US

(21) Appl. No.: 11/448,463

(22) Filed: Jun. 7, 2006

Related U.S. Application Data
(60) Provisional application No. 60/688,068, filed on Jun. 7, 2005.

(51) Int. Cl. G06K 19/00

(52) U.S. Cl. 235/487

(57) ABSTRACT

A portable reference tool of drink mixing cards, disposed on a key ring, and being carried in a pocket, and unobtrusively studied or consulted on the job.

### CROSS REFERENCE TO RELATED APPLICATION

This present application claims benefit of priority from U.S. Provisional Application Ser. No. 60/688,068, filed Jun. 7, 2005, entitled “POCKET DRINK CARDS”.

### FIELD OF THE INVENTION

The invention relates to reference books or cards such as recipe books or cards, and more particularly for recipe cards or books for mixing beverages or drinks.

### BACKGROUND OF THE INVENTION

Reference materials containing recipes or instructions for mixing and pouring of alcoholic drinks have been presented in many forms such as books, PDA's, etc. It is not generally possible to consult such a reference tool in an unobtrusive fashion. Thus both the study and consultation of the reference materials on the job is obvious. In addition, the compilation of recipes or instructions in a bound book is fixed, and recipes may not be easily added to or deleted. In contrast, the recipe content on a PDA is easily changeable, but the PDA is expensive.

Sets of paint chip samples, or samples of wooden floor laminate, have been distributed on key rings, or key chains. The manufacturer's label, or name for the sample, often appears on the reverse side of the sample. The sample sets are used as a portable reference for the appearance of the sample, to assist in, e.g., redecorating. Beyond its appearance, there is nothing to learn from the sample which is not a study aid. In addition, the samples are not intended to be consulted in an unobtrusive fashion, but to the contrary, in an obvious manner.

### SUMMARY OF THE INVENTION

It is an object of the present invention to provide a reference tool for learning, or consulting, how mix various drinks. It is a further object of the invention to provide a reference tool for, e.g., a bartender, or other server, to consult regarding the speed rak order of a typical bar, the count method, and the blood alcohol level for men and women, and a description of physical manifestations of a particular blood alcohol level. In addition it is an object of the present invention to provide such a study aid or reference tool which is small enough to be carried in a pocket. It is a further object of the present invention to provide such a study aid or reference tool which is small enough to be held within a fist, and consulted in an unobtrusive manner, so as to avoid any potential embarrassment in having to consult a reference book, i.e. on the job. It is a further object to provide an advertising medium for liquor manufacturers, wholesalers and retailers.

These objects, as well as other objects which will become apparent from the discussion that follows, are achieved, in accordance with the present invention, which comprises a portable reference tool containing instructions for making the various beverages and mixed drinks.

The portable reference tool comprises a stack of apertured cards disposed on a key ring. The key ring may be a traditional key chain, or an e.g. two piece ring with a pivot hinge and a clasp. The key ring may be opened for the addition or deletion of cards, and then re-closed. Each card carries complete instructions for mixing a particular drink. The reverse side of the card may bear simply the alphabetic indicia which distinguish this drink mixing card from another; or other drink recipe; or e.g., advertising. The instructions for mixing the drinks include not only a list of ingredients and method for mixing, but also include a picture and proper name for the glass in which the drink is traditionally served. Garnish choices for the drink are also included with the instructions.

The individual cards are sized to fit within the palm of an adult. The aperture is of sufficient diameter in relation to the diameter of the key ring such that the cards may be easily fanned for selection of the appropriate card, and the full face of the card exposed for reading the instructions. Preferably, the aperture is also of sufficient diameter in relation to the key ring that the cards, when stacked, form a smooth, rhomboid stack.

When the cards are fanned and a particular card selected, that particular drink mixing card may be placed on the top of the stack of cards which may be easily, and unobtrusively, held within the fist while reading the instructions. Thus the user of the set of cards may both study and consult the cards while avoiding any embarrassment of consulting a more traditional reference tool such as a book.

In addition to the drink mixing cards, the stack of cards may also include other essential information for bartenders or others who serve alcoholic drinks; such as thus the speed rack order and counting to method, along with blood alcohol level charts and blood alcohol level descriptions. Advertising, and in particular source advertising for the ringed stack of drink mixing cards, may also be included on one of the cards.

For a full understanding of the present invention, reference should now be made to the following detailed description of the preferred embodiments of the invention as illustrated in the accompanying drawings.

### BRIEF DESCRIPTION OF THE DRAWINGS

FIG. 1 is a top perspective view of the ringed, stacked, cards forming one embodiment of the reference tool of the present invention.

FIG. 2 is a right side view of the reference tool of FIG. 1.

FIG. 3 is a left side view of the reference tool of FIG. 1.

FIG. 4 is a top plan view of the key ring which may be used to form the reference tool of the present invention.

FIG. 5 is a side view of the key ring of FIG. 4.

FIG. 6A illustrates a title card for the stack of cards.

FIG. 6B illustrates the reverse side of the card shown in FIG. 6A, providing information as to the source of the cards.

FIGS. 7A and 7B illustrate the drink mixing card for an “Alabama Slammer”, including the glass selection, the ingredients and the directions for mixing.

FIGS. 8A and 8B illustrate the drink mixing card for an “Apple Martini”, including the glass selection, the ingredients and the directions for mixing.

FIGS. 9A and 9B illustrate the drink mixing card for a “B-52”, including the glass selection, the ingredients and the directions for mixing.

FIGS. 10A and 10B illustrate the drink mixing card for a “Zombie”, including the glass selection, the ingredients and the directions for mixing.

FIG. 11A illustrates the reference card for the “speed rack order”.

FIG. 11B illustrates the reference card for the “counting method”.

FIGS. 12A and 12B illustrate reference cards depicting blood alcohol level charts for men and women.

FIGS. 13A and 13B illustrate reference cards containing blood alcohol level descriptions.

FIG. 14 illustrates the reference tool in use, fanned in one hand, to locate the correct alphabetic indicia for the desired card.

FIG. 15 illustrates another embodiment of the reference tool in use, with a selected card hidden within the fist.

### DETAILED DESCRIPTION OF THE PREFERRED EMBODIMENTS

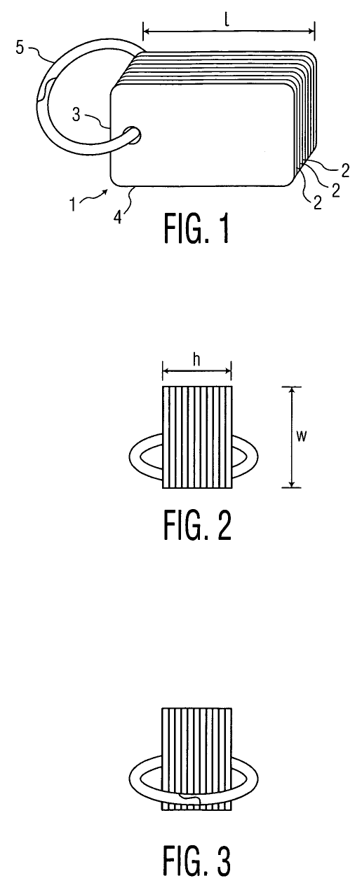

The preferred embodiments of the present invention will now be described with reference to FIGS. 1-15 of the drawings. Identical elements in the various figures are designated with the same reference numerals.

FIG. 1 illustrates a preferred embodiment of the portable reference tool of the present invention, shown generally at 1. This preferred embodiment comprises a stack of pocket drink cards, 2, disposed on the key ring, 5, which extends through an aperture, 3, at one end, 4, of the cards. As shown in FIGS. 1, 2, and 3, the drink mixing cards are generally rectangular, having a length, 1, and a width, w. The stack of cards has a height, h. In this preferred embodiment, the cards have a length of approximately 3 inches, and a width of approximately 1.5 inches; and the stack has a height of approximately 0.75 inches. Alternatively, the cards may be of any shape, such as an oval, the shape of a drink glass, or a liquor bottle. The cards may be constructed of laminar materials such as paper stock, plastic, or some combination thereof. For durability it is preferred that the cards be laminated with plastic.

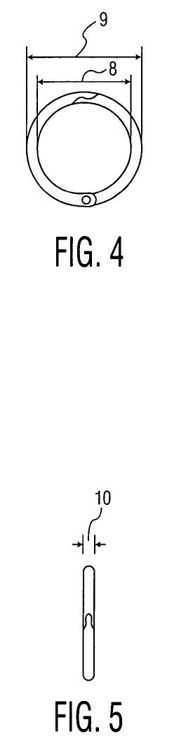

As shown in FIGS. 4 and 5, in this preferred embodiment the key ring is constructed of two pieces, joined at a pivot hinge, 7, and having a clasp, 6, which may be opened, and re-closed, to add and deleted drink mixing cards from stack. For ease of reference it is important that the aperture through the drink card be large enough, and the dimensions of the key ring [the inner diameter, 8, the outer diameter, 9, and the width, 10] small enough, to permit the cards to be easily moved along the ring, fanned to locate a particular card, and the stack easily reassembled with a particular card on top so that it can be easily read. In this regard the construction of the stack of drink cards differs from the collection of samples of e.g. paint chips, in it is not important that the entire chip be visible, but it is critical that the entire set of directions for mixing the drink be easily exposed for reading. Preferably, the aperture in each card is large enough, and the height of the stack small enough, that the edges of the stack may the smoothed to the aesthetically pleasing shape of a rhomboid.

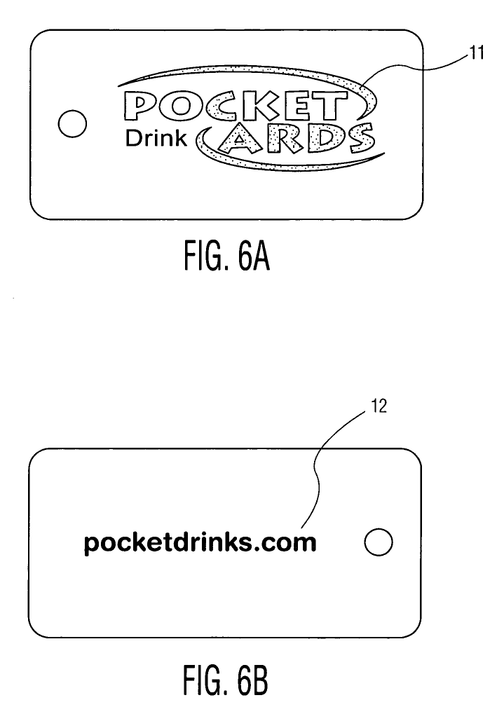

As shown in FIG. 6A one of the cards in the stack may bear a title, 11. In this preferred embodiment the reverse side of the card depicted in FIG. 6A may contain information as to the source, 12, of the cards as shown in FIG. 6B.

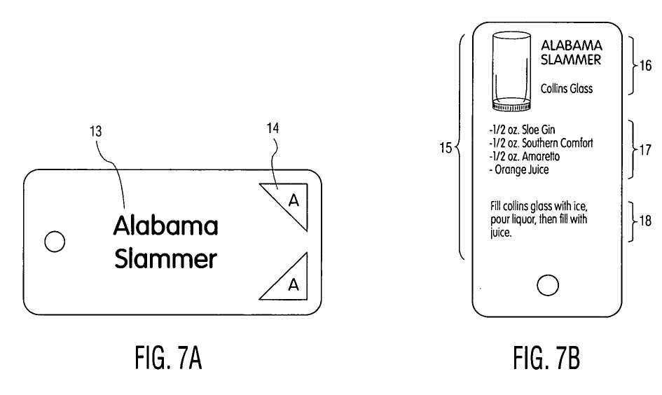

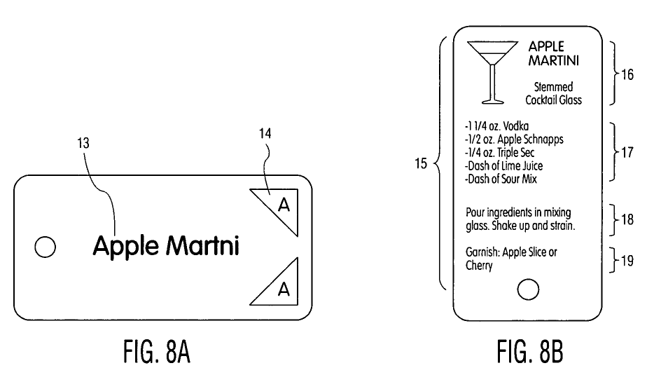

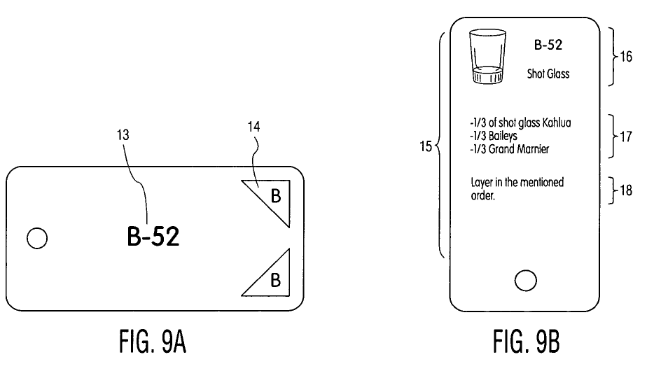

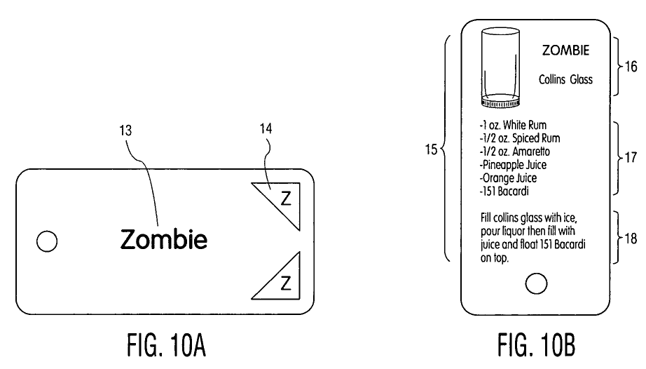

A preferred embodiment of the drink mixing card is shown in FIGS. 7A & 7B. On one side of the card, 7A, is the name, 13, of the drink, and alphabetical indicia, 14, disposed in the corner of the rectangular card, opposite the apertured end. The other side of the card, illustrated in FIG. 7B, bears the drink mixing instructions, 15, the name and picture of the glass in which the drink is traditionally served, 16, a list of the ingredients, 17, and the mixing instructions, 18. It is to be noted that these instructions are printed, or otherwise disposed, on the card such that the apertured end of the card at the bottom of the instructions. As shown in FIGS. 8A & 8B, the instructions for mixing the drink may also include a choice of garnish, 19. As shown in FIGS. 9A & 9B, the mixing instructions may in fact include layering rather than mixing. As shown in FIGS. 10A & 10B, the mixing instructions may also specify inclusion of ice in the glass in which the drink is to be served.

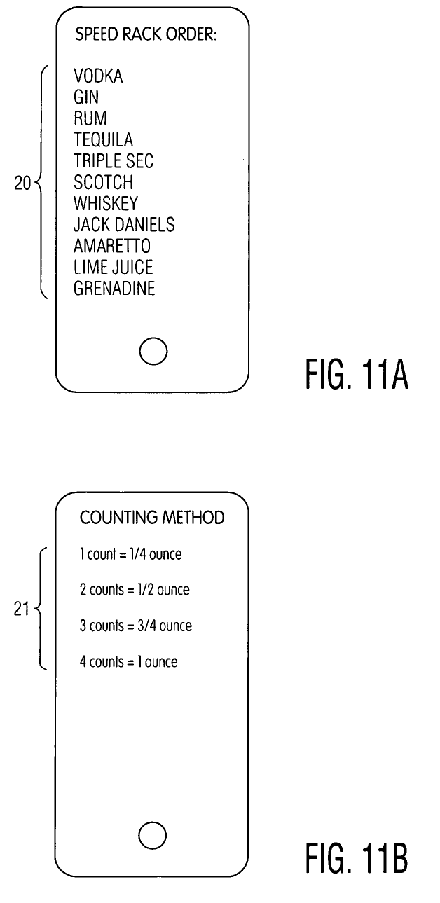

In this preferred embodiment of the portable reference tool, additional cards representing the training and expertise of a bartender may be included, such as the card in FIG. 11A which depicts the speed rack order, 20. In this preferred embodiment, the reverse side of the speed rack order, shown in FIG. 11B, presents the counting method, 21, which relates the counts to the volumes given in a list of ingredients.

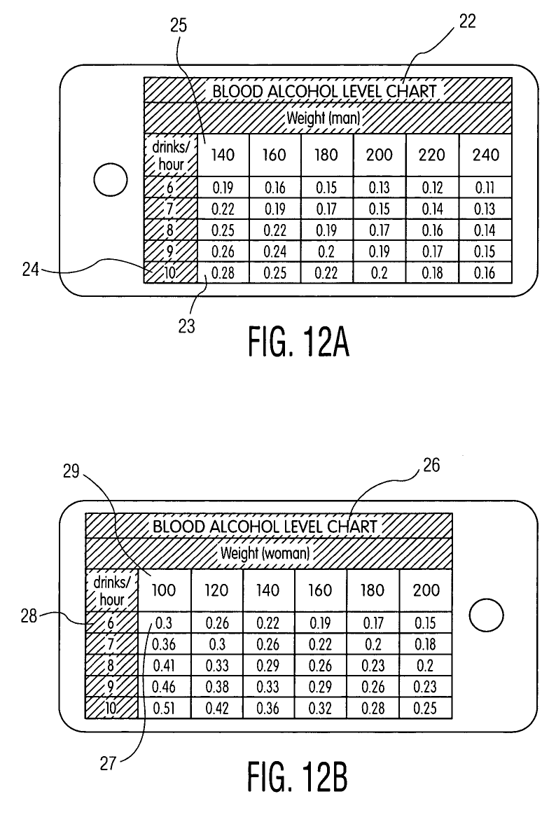

Additional cards of interest to both bartenders and others who serve alcoholic beverages are shown in FIGS. 12A & 12B. FIG. 12A presents a Blood Alcohol Level Chart for Men, 22, which includes the blood alcohol level, 23, predictable in a man who has drunk be particular number of drinks per hour, 24, and is of a particular body weight, 25. Similarly, FIG. 12B presents a Blood Alcohol Level Chart for Women, 26, which includes the blood alcohol level, 27, predictable in a woman who has drunk be particular number of drinks per hour, 28, and is of a particular body weight, 29.

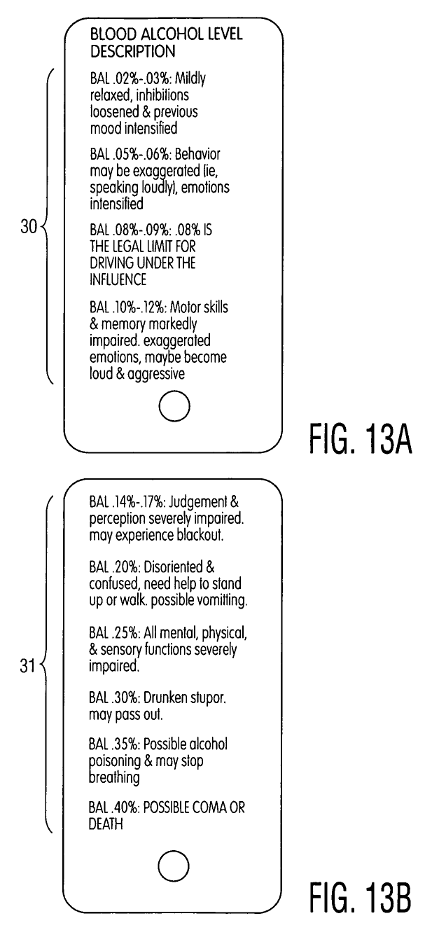

Another card included in this preferred embodiment of the reference tool is depicted in FIGS. 13A & 13B, and gives the blood alcohol level description, 30, on FIG. 13A, continued at 31 on FIG. 13B, which provides a description of the various bodily effects of a particular level of blood-alcohol.

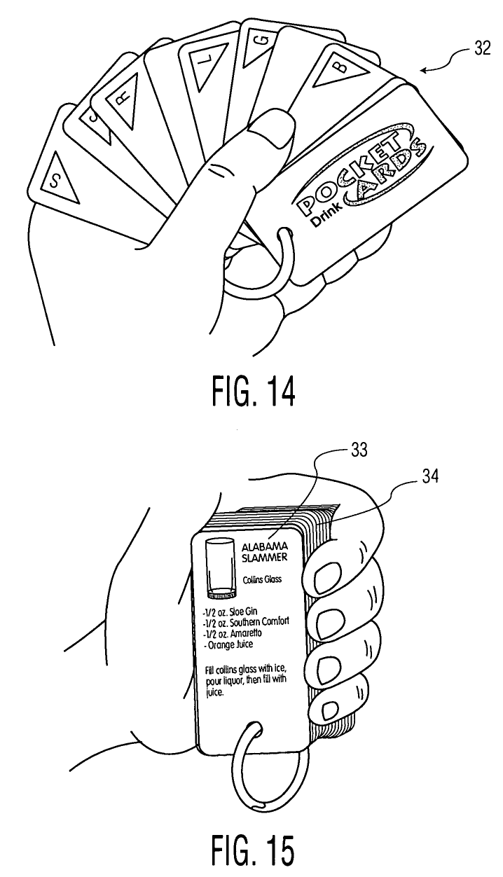

The cards, and stack, are sized to make it easy to refer to the instructions in an unobtrusive way. As shown in FIG. 14, the cards may be easily fanned, 32, and handled in one hand. Thus the user of the reference tool can fan the cards and select a particular card. The cards may be “restacked” to present one drink card instruction at a time for study or consultation. As shown in FIG. 15, the size, 33, of the cards, and the size, 34, of the stack, permit the reference tool to be used unobtrusively. The reference tool is small, secure and secret. In the preferred embodiment it is small enough to be carried in a pocket, making it easily portable. The drink cards are secure on the key ring, and cannot scatter like flash cards; but may be easily updated, unlike a bound book. The size and ease of manipulation of the preferred embodiment make the cards easy to consult in secret, without causing embarrassment for a bartender of discomfort in the customer.

There has thus been shown and described a novel portable reference tool for drink mixing cards which fulfills all the objects and advantages sought therefore. Many changes, modifications, variations and other uses and applications of the subject invention will, however, become apparent to those skilled in the art after considering this specification and the accompanying drawings which disclose the preferred embodiments thereof. All such changes, modifications, variations and other uses and applications which do not depart from the spirit and scope of the invention are deemed to be covered by the invention, which is to be limited only by the claims which follow.

What is claimed is:

1. A portable reference tool of instructions for making mixed drinks, said reference tool comprising:
a stack of at least two drink mixing cards; each drink mixing card bearing instructions for mixing a drink; each drink mixing card having an aperture at one end thereof at the bottom of the instructions;
a key ring disposed through the apertures in the cards such that the cards are readily movable along the ring, easily fanned, and easily turned, so that a particular card may be selected, and read, while the cards are disposed on the key ring.

2. The portable reference tool of claim 1, wherein each said card is substantially rectangular.

3. The portable reference tool of claim 1, wherein the key ring has a pivot hinge and a clasp.

4. The portable reference tool of claim 1, wherein each said card is small enough to be held within the palm of the hand, and said stack of cards is small enough to be enclosed within the fist.

5. The portable reference tool of claim 1, wherein the key ring is open-able and re-closable.

6. The portable reference tool of claim 1, wherein the cards are approximately 1.5″×3″.

7. The portable reference tool of claim 1, wherein the stack of cards is approximately 1.5″×3″×0.75″.

8. The portable reference tool of claim 1, wherein the instructions for mixing a drink comprise a list of ingredients and mixing instructions.

9. The portable reference tool of claim 8, wherein the instructions for mixing a drink further comprise a picture and name before the glass in which the drink may be served.

10. The portable reference tool of claim 1, further comprising an aperture card bearing a chart of the speed rack order.

11. The portable reference tool of claim 1, further comprising an aperture card bearing a chart of a volume counting method.

12. The portable reference tool of claim 1, further comprising an aperture card bearing a blood alcohol level charts for men and women.

13. The portable reference tool of claim 1, further comprising an aperture card bearing a chart of blood alcohol level description.

14. The portable reference tool of claim 3, the inner and outer diameter, and width, of the ring being small enough, and the aperture of the cards being of sufficient diameter in relation to the dimensions of the key ring, to permit the cards to be easily fanned to locate a particular card, and to permit the cards to be restacked to place the particular card on the top of the stack for study or consultation.

15. The portable reference tool of claim 1, where in the drink mixing cards are shaped like the silhouette of a drinking glass.

16. The portable reference tool of claim 1, where in the drink mixing cards are shaped like the silhouette of a liquor bottle.
